(19) United States
(12) Patent Application Publication
(10) Pub. No.: US 2005/0215241 A1
(43) Pub. Date: Sep. 29, 2005

(54) Mobile terminal communication restricting device, method and program

(75) Inventor: Tetsuro Okada, Tokyo (JP)

Correspondence Address: FOLEY AND LARDNER;SUITE 500, 3000 K STREET NW, WASHINGTON, DC, 20007, US

(73) Assignee: NEC CORPORATION

(21) Appl. No.: 11/088,910

(22) Filed: Mar. 25, 2005

(30) Foreign Application Priority Data
Mar. 25, 2004 (JP) 2004-090318

(51) Int. Cl. H04M 3/16

(52) U.S. Cl. 455/414.1; 455/403

(57) ABSTRACT

Synchronization of a wireless downlink in an existing mobile communication network is established and system notifying information from the existing mobile communication network is received. Synchronization of a wireless uplink in the existing mobile communication network is established and a layer-3 wireless channel establishment requesting message is received. A communication restricting state (ON/OFF state) for each service type (circuit switching service or packet switching service) is confirmed and the communication restricting state (ON/OFF state) is confirmed on the basis of a speed threshold value, based on a result of which confirmation, communication restriction is performed.

### BACKGROUND OF THE INVENTION

1. Field of the Invention

The present invention relates to a mobile terminal communication restricting device, and a mobile terminal communication restricting method and program used in the device and, more particularly to the mobile terminal communication restricting device, the mobile terminal communication restricting method and the mobile terminal communication restricting program that can be preferably used in a case of restricting and controlling communication by a mobile terminal such as a cellular phone in a place where its use is inappropriate, for example, in an automobile, a train, a movie theater, a hospital, or a like.

The present application claims priority of Japanese Patent Application No. 2004-090318 filed on Mar. 25, 2004, which is hereby incorporated by reference.

2. Description of the Related Art

Mobile terminals such as cellular phones have become widely used recently so that their users can speak over the phone anywhere and anytime. In spite of their benefit, however, accidents and adverse effects have occurred owing to mobile terminal use in an automobile, a train, a movie theater, a hospital, or a like. Although it is well known that to use the mobile terminals in the train, the movie theater, the hospital, or the like, calling is not completely restricted because some users forget to turn OFF the power of their mobile terminals or use them willfully, Further, as for use of mobile terminals in the automobile, use of a cellular phone during driving is prohibited in Japan by Item 5 of the fifth clause of the 71'st article of the Road Traffic Law in 1999, which is not completely observed either. Because of this, a device is proposed for controlling and restricting communication by the mobile terminal in a moving vehicle or within a specified location,

Conventionally, technologies for controlling and restricting communication by mobile terminal have been classified into the following types (1) through (4) as disclosed in Japanese Patent Applications.

(1) Technologies for performing communication restriction of the mobile terminal by using an electromagnetic wave, a new frequency, or a new restricting signal is provided:

With a portable terminal communication restricting device disclosed in Japanese Patent Application Laid-open No. 2003-174674 (Abstract, FIG. 1), opening/closing of a door of the automobile is detected, to transmit an electromagnetic wave which is used for restricting communication, thereby performing communication restriction on the mobile terminal.

With mobile radiotelephone equipment disclosed in Japanese Patent Application Laid-open No. 2000-201376 (Abstract, FIG. 4), a restriction information signal, which is different from a restricting signal from an existing mobile communication network, is transmitted from a sound wave transmitting set, to perform communication restriction on the mobile terminal.

With a mobile communication system disclosed in Japanese Patent Application Laid-open No. Hei 11-215562 (Abstract, FIG. 1), a utilization restricting signal, which is different from the restricting signal from the existing mobile communication network, is transmitted from a cellular phone utilization restricting device, to perform communication restriction on the mobile terminal.

With a method of restricting communication in mobile communication systems disclosed in Japanese Patent Application Laid-open No. Hei 9-275588 (Abstract, FIG. 1), an electromagnetic wave which is used for restricting communication is transmitted from restriction setting means, to perform communication restriction on the mobile terminal.

(2) Technologies for performing communication restriction of the mobile terminal by using positional information of the mobile terminal is provided;

With a wireless communication system disclosed in Japanese Patent Application Laid-open No. 2002-101454 (Abstract, FIG. 2), positional information of the mobile terminal is acquired through a global positioning system (GFS), so that if the position falls in an incoming-call notification-restricted region or a call-restricted region, respectively an incoming-call notification restricting signal or a call restricting signal is inserted in an allocated traffic channel and, when this signal is received by the mobile terminal, communication restriction is performed on the mobile terminal.

With a mobile wireless system disclosed in Japanese Patent Application Laid-open No. Hei 7-231472 (Abstract, FIG. 1), positional information of the mobile terminal is identified by a wireless base station, to perform communication restriction on the mobile terminal.

(3) Technologies for performing communication restriction of the mobile terminal by using call-disconnection requesting message:

With a device which performs communication restriction on mobile terminals disclosed in Japanese Patent Application Laid-open No. 2000-350260 (Abstract, FIG. 2), when a layer-3 wireless channel is established, a call-disconnection requesting message used in an existing mobile communication network is transmitted from the communication restricting device to the mobile terminal, to perform communication restriction on the mobile terminal.

(4) Technologies for performing communication restriction of the mobile terminal by using jamming is provided:

With a method fox restricting communication through cellular phones disclosed in Japanese Patent Application Laid-open No. 2002-125267 (Abstract, FIG. 1), a control channel between the mobile terminal and a wireless base station is monitored by a jamming device, so that jamming is generated only to a communication wireless channel.

However, the technologies described in the above patent documents have the following problems.

That is, in the case of technologies (1) for performing communication restriction by using the electromagnetic wave, the new frequency, or the new restricting signal, the electromagnetic wave, new frequency, and new restricting signal are not used in the existing mobile communication network, so that frequencies for use of the electromagnetic wave or the new frequency need to be allocated and, besides, the mobile terminal needs to be provided with a new function to receive the electromagnetic wave, the new frequency, or the new restricting signal, which are difficult to realize, problematically.

In the case of technologies (2) for performing communication restriction by using the positional information of the mobile terminal, if the inside of the automobile or the train is defined as the communication-restricted area, the mobile communication network needs to detect positional information also of the automobile or the train and, besides, the mobile terminal, the automobile, the train, or the like need to be equipped with positional information detection means such as the GPS, which complicates a configuration, problematically.

Technologies (3) for performing communication restriction by using the call-disconnection requesting message have a problem that when the call-disconnection requesting message is used, communication restriction is performed on all of calls-out and calls-in regardless of a service type (circuit switching service or packet switching service).

Technologies (4) for performing communication restriction by using jamming involve a provision of the jamming generator and so depart from the gist of the present invention.

### SUMMARY OF THE INVENTION

In view of the above, it is an object of the present invention to provide a mobile terminal communication restricting device, and a mobile terminal communication restricting method and program used in the device that can be preferably used in a case of restricting and controlling communication by a mobile terminal such as a cellular phone in a place where its use is inappropriate, for example, in an automobile, a train, a movie theater, a hospital, or a like.

According to a first aspect of the present invention, there is provided a mobile terminal communication restricting device for performing communication restriction on a call-in or call-out occurring between a mobile terminal, which is wireless-connected to an existing communication network that is based on an Open Interconnection protocol, and the existing mobile communication network if the mobile terminal is within a moving vehicle or within a specified location, the mobile terminal communication restricting device: configured to transmit to the mobile terminal a communication restricting message, which is actually used in said existing mobile communication network, for informing the mobile terminal of performing the communication restriction on a layer-3 of the Open Systems Interconnection protocol, it the call-in or call-out has occurred between the mobile terminal and the existing mobile communication network.

In the foregoing first aspect, a preferable mode is one that wherein is provided with a communication restricting switch for determining, by switchover, whether to perform the communication restriction so that if a layer-3 wireless channel establishment requesting message actually used in the existing mobile communication network is received from the mobile terminal when the communication restricting switch is ON, a layer-3 wireless channel rejecting message actually used in the existing mobile communication network is transmitted to the mobile terminal, to perform the communication restriction on the mobile terminal.

Also, a preferable mode is one that wherein is provided with a communication restricting switch for determining, by switchover, whether to perform the communication restriction so that if a layer-3 wireless channel establishment requesting message actually used in the existing mobile communication network is received from the mobile terminal when the communication restricting switch is OFF and, after that, the communication restricting switch is turned ON, a layer-3 wireless channel disconnecting message actually used in the existing mobile communication network is transmitted to the mobile terminal, to perform the communication restriction on the mobile terminal.

Also, a preferable mode is one that wherein is further configured to identify service type information indicative of circuit switching service or packet switching service based on the layer-3 wireless channel establishment requesting message received from the mobile terminal, and to transmit the layer-3 wireless channel rejecting message to the mobile terminal using at least one of the circuit switching service and the packet switching service.

Also, a preferable mode is one that wherein is further configured to identify service type information indicative of circuit switching service or packet switching service based on the layer-3 wireless channel establishment requesting message received from the mobile terminal, and to transmit the layer-3 wireless channel disconnecting message to the mobile terminal using at least one of the circuit switching service and the packet switching service.

Also, a preferable mode is one that wherein is configured to perform the communication restriction only when a moving speed of the vehicle has exceeded a predetermined speed threshold value, when mounted in the vehicle.

According to a second aspect of the present invention, there is provided a communication restricting method used in a mobile terminal communication restricting device for performing communication restriction on a call-in or call-out occurring between a mobile terminal, which is wireless-connected to an existing communication network that is based on an Open Systems Interconnection protocol, and the existing mobile communication network if the mobile terminal is within a moving vehicle or within a specified location, the method including the steps of:
checking whether the call-in or call-out has occurred between the mobile terminal and the existing mobile communication network; and
transmitting to the mobile terminal a communication restricting message, which is actually used in said existing mobile communication network, for informing the mobile terminal of performing the communication restriction on a layer-3 of the Open Systems Interconnection protocol, if the call-in or call-out has occurred.

In the foregoing second aspect, a preferable mode is one that wherein further includes: using a communication restricting switch for determining, by switchover, whether to perform the communication restriction so that if a layer-3 wireless channel establishment requesting message actually used in the existing mobile communication network is received from the mobile terminal when the communication restricting switch is ON, a layer-3 wireless channel rejecting message actually used in the existing mobile communication network is transmitted to the mobile terminal, to perform the communication restriction on the mobile terminal.

Also, a preferable mode is one that wherein further includes the step of: using a communication restricting switch for determining, by switchover, whether to perform the communication restriction so that if a layer-3 wireless channel establishment requesting message actually used in the existing mobile communication network is received from the mobile terminal when the communication restricting switch is OFF and, after that, the communication restricting switch is turned ON, a layer-3 wireless channel disconnecting message actually used in the existing mobile communication network is transmitted to the mobile terminal, to perform the communication restriction on the mobile terminal.

Also, a preferable mode is one that wherein further includes the step of: identifying service type information indicative of circuit switching service or packet switching service based on the layer-3 wireless channel establishment requesting message received from the mobile terminal, and transmits the layer-3 wireless channel rejecting message to the mobile terminal using at least one of the circuit switching service and the packet switching service.

Also, a preferable mode is one that wherein further includes the step of: identifying service type information indicative of circuit switching service or packet switching service based on the layer-3 wireless channel establishment requesting message received from the mobile terminal, and transmits the layer-3 wireless channel disconnecting message to the mobile terminal using at least one of the circuit switching service and the packet switching service.

Also, a preferable mode is one that wherein further includes the step of; performing the communication restriction only when a moving speed of the vehicle has exceeded a predetermined speed threshold value, and when the mobile terminal communication restricting device is mounted in the vehicle.

According to a third aspect of the present invention, there is provided a communication restricting program for causing a computer to execute a communication restricting method used in a mobile terminal communication restricting device for performing communication restriction on a call-in or call-out occurring between a mobile terminal, which is wireless-connected to an existing communication network that is based on an Open Systems Interconnection protocol, and the existing mobile communication network if the mobile terminal is within a moving vehicle or within a specified location, the method including:
checking whether the call-in or call-out has occurred between the mobile terminal and the existing mobile communication network; and
transmitting to the mobile terminal a communication restricting message, which is actually used in said existing mobile communication network, for informing the mobile terminal of performing the communication restriction on a layer-3 of the Open Systems Interconnection protocol, if the call-in or call-out has occurred.

In the foregoing third aspect, a preferable mode is one that wherein further includes: the method further including the step of: using a communication restricting switch for determining, by switchover, whether to perform the communication restriction so that if a layer-3 wireless channel establishment requesting message actually used in the existing mobile communication network is received from the mobile terminal when the communication restricting switch is ON, a layer-3 wireless channel rejecting message actually used in the existing mobile communication network is transmitted to the mobile terminal, to perform communication restriction on the mobile terminal.

Also, a preferable mode is one that wherein further includes: the method further including the step of: using a communication restricting switch for determining, by switchover, whether to perform the communication restriction so that if a layer-3 wireless channel establishment requesting message actually used in the existing mobile communication network is received from the mobile terminal when the communication restricting switch is OFF and, after that, the communication restricting switch is turned ON, a layer-3 wireless channel disconnecting message actually used in the existing mobile communication network is transmitted to the mobile terminal, to perform communication restriction on the mobile terminal.

Also, a preferable mode is one that wherein further includes: causing a computer to execute identifying service type information indicative of circuit switching service or packet switching service based on the layer-3 wireless channel establishment requesting message received from the mobile terminal, and transmitting the layer-3 wireless channel rejecting message to the mobile terminal using at least one of the circuit switching service and the packet switching service.

Also, a preferable mode is one that wherein further includes: causing a computer to execute further identifying service type information indicative of circuit switching service or packet switching service based on the layer-3 wireless channel establishment requesting message received from the mobile terminal, and transmitting the layer-3 wireless channel disconnecting message to the mobile terminal using at least one of the circuit switching service and the packet switching service.

With the configurations as above, a mobile terminal communication restricting device transmits to a mobile terminal an OSI protocol layer-3 wireless channel rejecting message or layer-3 wireless channel disconnecting message, which are communication restricting messages actually used in an existing mobile communication network, so that it is possible to perform communication restriction without remodeling the mobile terminal or allocating a new frequency. Further, the mobile terminal communication restricting device identifies a service type (circuit switching service or packet switching service) based on a received layer-3 wireless channel establishment requesting message, so that it is possible to perform communication restriction on at least one of the service types (for example, circuit switching service). Further, when mounted in a vehicle (for example, an automobile), the mobile terminal communication restricting device can perform communication restriction on the mobile terminal without an existing mobile communication network having to detect or monitor positional information of the mobile terminal or the vehicle. Furthermore, the mobile terminal communication restricting device performs communication restriction on the mobile terminal if a moving speed of the vehicle is detected to have exceeded a predetermined speed threshold value, so that when the vehicle mounted with the communication restricting device is at a halt, it is possible to prevent communication restriction from being performed on the mobile terminal.

### BRIEF DESCRIPTION OF THE DRAWINGS

The above and other objects, advantages, and features of the present invention will be more apparent from the following description taken in conjunction with the accompanying drawings, in which:

FIG. 1 is a diagram for showing an environment in which a mobile terminal communication restricting device according to an embodiment of the present invention is used;

FIG. 2 is a diagram for showing a configuration of an OSI protocol according t the same embodiment;

FIG. 3 is a block diagram for showing an electric configuration of a communication restricting device of FIG. 1; and

FIG. 4 is an explanatory flowchart of operations of the communication restricting device according t the same embodiment.

### DETAILED DESCRIPTION OF THE PREFERRED EMBODIMENTS

Best mode of carrying out the present invention will be described in further detail using various embodiments with reference to the accompanying drawings.

A mobile terminal communication restricting device is provided which, when a call-in or call-out has occurred between a mobile terminal and an existing mobile communication network, transmits to the mobile terminal a communication restricting message for informing the mobile terminal of performing communication restriction on layer 3 of an OSI (Open Systems Interconnection) protocol, which is actually used in the existing mobile communication network.

### Embodiment

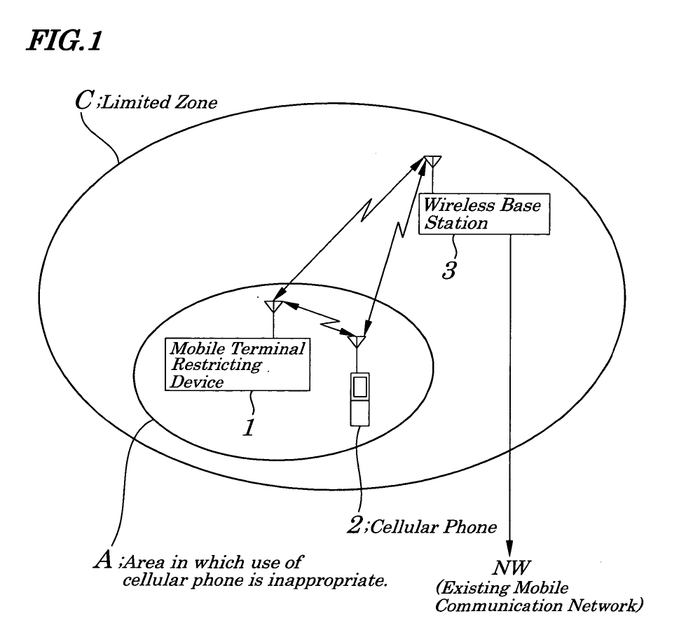

FIG. 1 is a diagram for showing an environment in which a mobile terminal communication restricting device according to an embodiment of the present invention is used.

The mobile terminal communication restricting device 1 according to the present embodiment is placed in an area A (for example, inside of an automobile, a train, a movie theater, a hospital, or a like) in which use of a mobile terminal (for example, cellular phone 2) is inappropriate, as shown in FIG. 1. The area A is within a limited zone C over which a wireless base station 3 has jurisdiction. The wireless base station 3 is cable-connected to an existing mobile communication network NW that is based on an OSI (Open Systems Interconnection) protocol. The existing mobile terminal network NW is made up of a plurality (only one is shown for simplification) of the wireless base stations 3 and a mobile communication control station, an in-sphere mobile communication switching center, a barrier mobile communication switching center, and an ordinary telephone circuit, which are not shown.

When a call-in or call-out has occurred on the cellular phone 2, the cellular phone 2 transmits a layer-3 wireless channel establishment requesting message based on the OSI protocol to the wireless base station 3, which message is received by the mobile terminal communication restricting device 1, if this message has been transmitted when the call-in or call-out had occurred on this cellular phone 2 in the area A. When having received the layer-3 wireless channel establishment requesting message, the mobile terminal communication restricting device 1 transmits to the cellular phone 2 an OSI-protocol layer-3 wireless channel rejecting message or layer-3 wireless channel disconnecting message, which are communication restricting messages actually used in the existing mobile communication network NW, in accordance with whether a communication restricting switch, not shown, is in an ON/OFF state respectively, thereby performing communication restriction on the cellular phone 2.

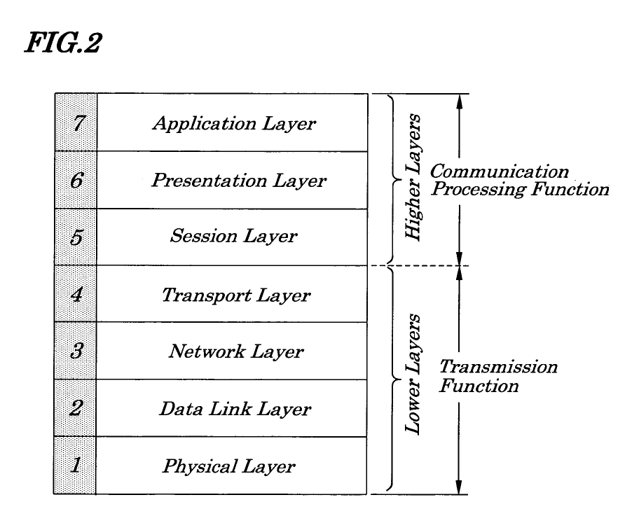

FIG. 2 is a diagram for showing a configuration of the OSI protocol used in the existing mobile communication network.

The OSI protocol is used to realize high degree functions by connecting, by communication, facilities in a system to those in another system so that they may work in cooperation with each other.

As shown in FIG. 2, the OSI protocol is made up of layers 1, 2, . . . , 7, layers 1-4 of which are referred to as lower layers and layers 5-7 of which are referred to as higher layers. The lower layers handle a transmission function of directly sending data to a party on the other end of the phone connection and the higher layers handle a function related to communication processing. A wireless interface of a mobile communication network such as a personal digital cellular (PDC) system or a wideband code division multiple access (WCDMA) system is made up of layers 1-3 out of the lower layers.

Layer 1 (physical layer), is used to directly control a communication line made of a physical medium, performs modulation and spreading, error detection, synchronization between frequencies and time, or a like in a mobile communication network. Layer 2 (data link layer), is used to control data transmission between stations directly connected to each other physically, performs message assembly and disassembly, error correction, or a like in the mobile communication network. Layer 3 (network layer), is used to relay data by selecting a path from a network having a complicated configuration, performs wireless transmission control, mobile management control, call connection control, or a like.

Layer 4 (transport layer) makes it possible to transmit the same data between various networks irrespective of a line to be used. It provides for a function to absorb a difference between the networks. Layer 5 (session layer) decides a transmission right that determines which one of parties would send data in the case of half-duplex transmission. Further, it conducts such control as to define a synchronization point agreed by a transmission side for the purpose of re-transmission upon error occurrence. Layer 6 (presentation layer) controls a data representation format in the case of possible disagreement of character codes, a screen control method, and numeric data between systems that exchange data with each other and also performs data encryption, data compression, or a like. Layer 7 (application layer) provides for service jobs such as file transfer, e-mails, and databases but does not restrict communication.

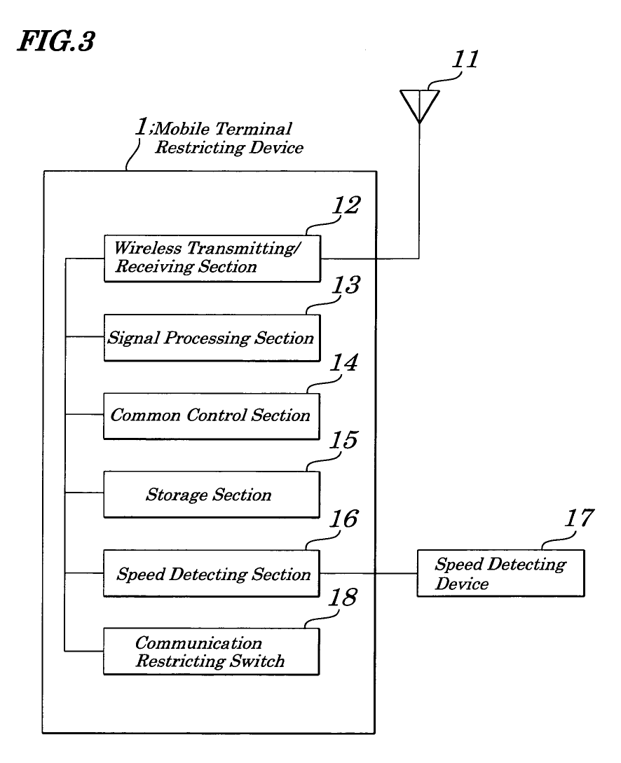

FIG. 3 is a block diagram for showing an electrical configuration of the mobile terminal communication restricting device 1 as shown in FIG. 1.

As shown in FIG. 3, the mobile terminal communication restricting device 1 is made up of an antenna 11, a wireless transmitting/receiving section 12, a signal processing section 13, a common control section 14, a storage section 15, a speed detecting section 16, a speed detecting device 17, and a communication restricting switch 18. The antenna 11 is used to transmit and receive radio waves transferred between the cellular phone 2 and the wireless base station 3. The wireless transmitting/receiving section 12 converts a transmitting signal (containing a layer-3 wireless channel message) processed by the signal processing section 13 into a modulated transmitting signal by performing quadrature modulation and spread modulation on the transmitting signal, amplifies signal power of the modulated transmitting signal, and transmits the amplified transmitting signal to the antenna 11, and also amplifies power of a signal received through the antenna 11, demodulates the received signal, and transmits the demodulated received signal to the signal processing section 13. The signal processing section 13 performs error correcting coding, framing, or a like on the transmitting signal, and also performs inverse spread modulation, synchronization, error-correction decoding, data multiplexing/separation, or a like on the received signal.

The common control section 14 is made up of, for example, a central processing unit (CPU) (not shown), to control each of components making up mobile terminal communication restricting device 1 by using its function to control call processing, function to control a bus in the mobile terminal communication restricting device 1, function to control monitoring, function to confirm a state of the communication restricting switch 18 (for example, communication restricting state counter, not shown), or a like. The storage section 15 is made up of, for example, a read only memory (ROM)(not shown), to store a communication restricting program required to operate the CPU in the common control section 14. Further, the storage section 15 stores a program file and a data file that are required to operate the mobile terminal communication restricting device 1. In addition, the storage section 15 stores system notifying information, layer-3 wireless channel establishment requesting message information, a speed threshold value (0−∞ km/h) used to run communication restricting program, communication restricting conditions for each service type (circuit switching service or packet switching service), or a like. The speed detecting section 16 detects a speed from the speed detecting device 17 mounted in, for example, an automobile or vehicle. The communication restricting switch 18 is used to determine, by switchover, whether to perform communication restriction on the cellular phone 2.

The mobile terminal communication restricting device 1, when having received a layer-3 wireless channel establishment requesting message from the cellular phone 2 used in the existing mobile communication network NW when the communication restricting switch 18 is in the ON state, transmits a layer-3 wireless channel rejecting message used in the existing mobile communication network NW, to the cellular phone 2. Further, the mobile terminal communication restricting device 1 receives a layer-3 wireless channel establishment requesting message used in the existing mobile communication network NW from the cellular phone 2 when the communication restricting switch 18 is in the OFF state and then, when the communication restricting switch 18 is turned ON, transmits a layer-3 wireless channel disconnecting message used in the existing mobile communication network NW to the cellular phone 2 as a communication restricting message. Further, the mobile terminal communication restricting device 1 identifies service type information indicative of circuit switching service or packet switching service based on the layer-3 wireless channel establishment requesting message received from the cellular phone 2, and transmits a layer-3 wireless channel rejecting message to the cellular phone 2 using at least one of the circuit switching service and the packet switching service. Further, the mobile terminal communication restricting device 1 identifies the service type information indicative of circuit switching service or packet switching service from the layer-3 wireless channel establishment requesting message received from the cellular phone 2, and transmits a layer-3 wireless channel disconnecting message to the cellular phone 2 using at least one of the circuit switching service and the packet switching service. Further, the mobile terminal communication restricting device 1 performs communication restriction only when a moving speed of a vehicle (for example, the automobile) mounted with the mobile terminal communication restricting device 1 exceeds a predetermined speed threshold value.

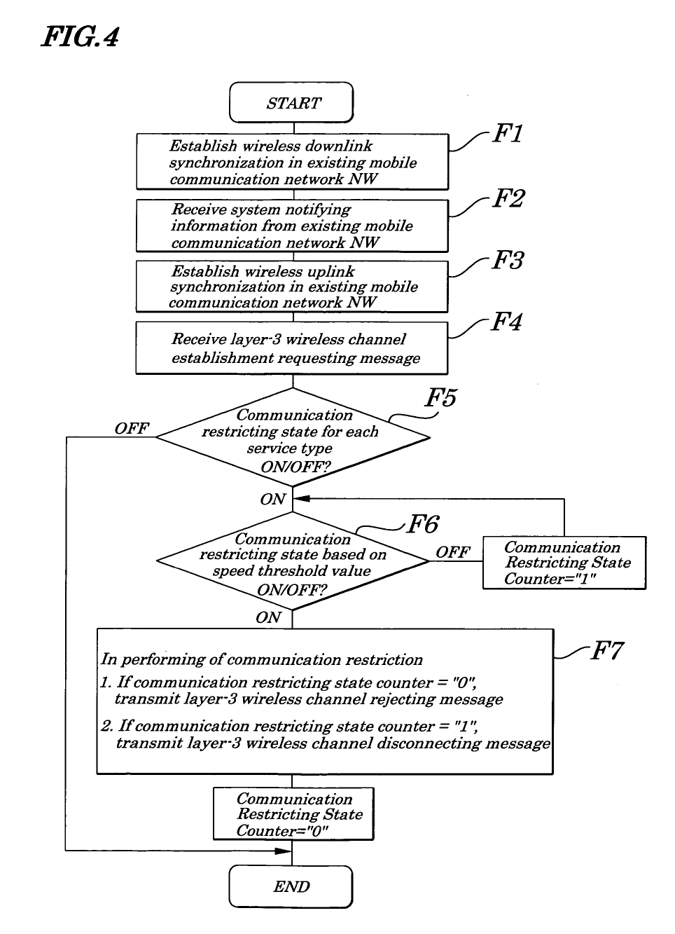

FIG. 4 is an explanatory flowchart of operations of the mobile terminal communication restricting device 1.

The following will describe contents of processing performed by a communication restricting method employed in a mobile terminal communication restricting device of the present embodiment, with reference to FIG. 4.

(1) Establishment of synchronization with wireless downlink in existing mobile communication network NW (step F1)

To transmit to the cellular phone 2 a layer-3 wireless channel message of the OSI protocol used in the existing mobile communication network NW and receive system notifying information from the existing mobile communication network NW, the mobile terminal communication restricting device 1 establishes synchronization with a wireless downlink in the existing mobile communication network NW.

As a method of establishing synchronization with the wireless downlink, the same method is applied as a procedure for establishing synchronization with the wireless downlink performed between the existing mobile communication network NW and the cellular phone 2. For example, when a communication protocol is applied to a personal digital cellular (POC) system, synchronization with the wireless downlink is established between the mobile terminal communication restricting device 1 and the wireless base station 3 connected to a PDC mobile communication network by common access channel frame synchronization or a like. If it is applied to a wideband CDMA (WCDMA) system, on the other hand, wireless downlink synchronization is established between the mobile terminal communication restricting device 1 and the wireless base station 3 connected to a WCDMA mobile communication network by cell search, slot synchronization, frame synchronization, scramble code recognition, common control physical channel synchronization, or a like. The wireless downlink synchronization is established not only with the wireless base station 3 but also with all the wireless base stations 3 (only one is shown in FIG. 1) from which the mobile terminal communication restricting device 1 receives information. For example, if the mobile terminal communication restricting device 1 is located at a boundary between the limited zones C over which at least two wireless base stations 3 have jurisdiction respectively, the mobile terminal communication restricting device 1 establishes synchronization with the wireless downlink for each of these two wireless base stations 3.

(2) Reception of system notifying information from existing mobile communication network NW (step F2):

After synchronization with the wireless downlink is established, the mobile terminal communication restricting device 1 receives system notifying information to be transmitted from the existing mobile communication network NW to the cellular phone 2. The system notifying information contains network information, mobile terminal information, physical channel information, a transport channel state, or a like that are required to transmit and receive messages on the layer-3 wireless channel. The mobile terminal communication restricting device 1 receives system notifying information used between the existing mobile communication network NW and the cellular phone 2. For example, if a communication restriction is applied to the PDC system, the mobile terminal communication restricting device 1 receives system notifying information on notification channels (BCCH; broadcast CHannel, or a like), from the PDC mobile communication network. If it is applied to the WCDMA system, on the other hand, the mobile terminal communication restricting device 1 receives system notifying information on primary common control physical channels (P-CCPCH, primary common control physical channel, or a like) from the WCDMA mobile communication network. This system notifying information is received not only from the wireless base station 3 but also from all the wireless base stations 3 from which the mobile terminal communication restricting device 1 receives the information. For example, if the mobile terminal communication restricting device 1 is located at a boundary between the limited zones C over which at least two wireless base stations 3 have jurisdiction respectively, the mobile terminal communication restricting device 1 receives notifying information from each of these two wireless base stations 3.

(3) Establishment of synchronization with wireless uplink in existing mobile communication network NW:

To receive a layer-3 wireless channel message to be transmitted from the cellular phone 2 to the existing mobile communication network NW, the mobile terminal communication restricting device 1 needs to establish synchronization with a wireless uplink of the existing mobile communication network NW. As a method of establishing synchronization with this wireless uplink, the same method is applied as a procedure for establishing synchronization with the wireless uplink actually performed between the cellular phone 2 and the wireless base station 3 connected to the existing mobile communication network NW. For example, when a communication protocol is applied to the PDC system, synchronization with the wireless uplink is established between the mobile terminal communication restricting device 1 and a PDC mobile terminal (for example, the cellular phone 2) when the mobile terminal communication restricting device 1 receives a synchronization burst signal from the PDC mobile terminal. If it is applied to the WCDMA system, on the other hand, synchronization with the wireless uplink is established between the mobile terminal communication restricting device 1 and a WCDMA mobile terminal (for example, the cellular phone 2) when the mobile terminal communication restricting device 1 receives a preamble from the WCDMA mobile terminal. The wireless uplink synchronization is established not only with the cellular phone 2 but also with all cellular phones 2 (only one is shown in FIG. 1) in the area A.

(4) Reception of layer-3 wireless channel establishment requesting message (step F4);

Now that the mobile terminal communication restricting device 1 has received the system notifying information from the existing mobile communication network NW and established wireless uplink synchronization with the cellular phone 2, the mobile terminal communication restricting device 1 receives a layer-3 wireless channel establishment requesting message to be transmitted from the cellular phone 2 to the wireless base station 3. When a call-in or call-out has occurred on the cellular phone 2, the cellular phone 2 transmits a layer-3 wireless channel establishment requesting message to the existing mobile communication network NW. If the call-in or call-out has occurred in the area A, the mobile terminal communication restricting device 1 receives the layer-3 wireless channel establishment requesting message through the wireless uplink synchronization established at the above step F3, to acquire information such as a type of service (circuit switching service/packet switching service), a type of the mobile terminal, and a type of the message from this message. As the layer-3 wireless channel establishment requesting message, the same message is applied as a layer-3 wireless channel establishment requesting message used in the existing mobile communication network NW.

For example, if the communication protocol is applied to a PDC system, the mobile terminal communication restricting device 1 receives an I (information) [notification of outgoing-signal wireless state, -, call setting] message (where “-” indicates transmission not being performed) or an I [notification of incoming-signal wireless state, -, call setting] message from the PDC mobile terminal (for example, cellular phone 2) in the case of circuit switching service and, in the case of packet switching service, receives a VI (unnumbered information) [-, request for registering of packet communication, -] message. The I (information) and the UI (unnumbered information) each are made up of [RT (radio frequency transmission management, wireless management) message, MM (mobility management) message, CC (call control) message], in which all of these messages are multiplexed. Further, if the communication protocol is applied to a WCDMA system, on the other hand, the mobile terminal communication restricting device 1 receives from a WCDMA mobile terminal a “radio resource control (RRC) connection request” (connection request) message containing information such as a service type and a mobile terminal type.

(5) Confirmation of communication restricting state (ON/OFF state) for each service type (circuit switching service or packet switching service) (step F5):

The mobile terminal communication restricting device 1 confirms predetermined communication restricting states for each service type, that is, a communication restricting state (ON/OFF state) for circuit switching service and a communication restricting state (ON/OFF state) for packet switching service. The mobile terminal communication restricting device 1 decides whether a layer-3 wireless channel establishment request asks for circuit switching service or packet switching service based on a service type (circuit switching service or packet switching service) or a message type contained in a layer-3 wireless channel establishment message received from the cellular phone 2 and, therefore, decides whether to perform communication restriction on the received layer-3 wireless channel establishment requesting message based on the communication restricting state (ON/OFF state) of the circuit switching service or the packet switching service and, if it is ON, goes to step F6. In the case of a WCDMA system, the circuit switching service is further classified into conversation service and streaming service and the packet switching service is further classified into interactive service, background service and streaming service. It is possible to make settings on whether to perform communication restriction on these classified service types.

(6) Confirmation of communication restricting state (ON/OFF) based on speed threshold value (step F6):

The mobile terminal communication restricting device 1 confirms a communication restricting state (ON/OFF state) based on a speed threshold value. The mobile terminal communication restricting device 1 acquires a speed of an automobile or a train mounted with the mobile terminal communication restricting device 1 by using the speed detecting section 16 connected to the speed detecting device 17 of FIG. 3 that is equipped to the automobile or the train. If the speed is in excess of a preset speed threshold value, the process goes to step F7 (7-1) to perform communication restriction. In this case, a value of the communication restricting state counter is “0”. If the speed is not in excess of the preset speed threshold value, on the other hand, no communication restriction is performed, to update the value of the communication restricting state counter to “1”. After this, if the speed of the automobile or the train mounted with the mobile terminal communication restricting device 1 exceeds the speed threshold value, the process goes to step F7 (7-2) in condition where the communication restricting counter value remains at “1”.

(7) Performing of communication restriction (step F7):

(7-1) In the case where the communication restricting state is ON upon reception of the layer-3 wireless channel establishment requesting message

By using the information such as a service type (circuit switching service or packet switching service) and a mobile terminal type acquired when it has received the layer-3 wireless channel establishment requesting message at the above step F4, the mobile terminal communication restricting device 1 transmits to the cellular phone 2 a layer-3 wireless channel rejecting message actually used in the existing mobile communication network NW. The layer-3 wireless channel rejecting message is specifically transmitted by the mobile terminal communication restricting device 1 to the cellular phone 2 based on the wireless downlink synchronization established at the above step F1. As this layer-3 wireless channel rejecting message, the same message is applied as in a layer-3 wireless channel rejecting message used in the existing mobile communication network NW.

For example, if the communication protocol is applied to a PDC system, an I [mobile station release message, -, release completed] message is transmitted from the mobile terminal communication restricting device 1 to a PDC mobile terminal in the case of circuit switching service and, in the case of packet switching service, a UI [-, packet channel registration rejected, -] message is transmitted, to perform communication restriction. If the communication protocol is applied to a WCDMA system, on the other hand, a “radio resource control (RRC) connection reject” (connection rejection) message is transmitted from the mobile terminal communication restricting device 1 to a WCDMA mobile terminal, to perform communication restriction. That the communication restricting state is ON upon reception of the layer-3 wireless channel establishment requesting message is decided on the basis of the value (=0) of the communication restricting state counter, not shown, in the common control section 14 for confirmation of the state of the communication restricting switch 18.

(7-2) In the case where the communication restricting state has been OFF upon reception of the layer-3 wireless channel establishment requesting message and, after that, is turned ON:

When the communication restricting state is OFF, the mobile terminal communication restricting device 1 holds the information such as a service type (circuit switching service or packet switching service) and a mobile terminal type acquired when it has received the layer-3 wireless channel establishment requesting message at the above step F4. After that, the layer-3 wireless channel is established, so that when the communication restricting state is turned ON during calling, the mobile terminal communication restricting device 1 transmits to the cellular phone 2 a layer-3 wireless channel disconnecting message actually used in the existing mobile communication network NW, based on the held information. The layer-3 wireless channel disconnecting message is specifically transmitted by the mobile terminal communication restricting device 1 to the cellular phone 2 based on the wireless downlink synchronization established at the above step F1. As this layer-3 wireless channel disconnecting message, the same message is applied as a layer-3 channel disconnecting message used in the existing mobile communication network NW.

For example, if the communication protocol is applied to a PDC system, the mobile terminal communication restricting device 1 transmits a UI [layer-3 wireless channel disconnect, -, -] message or a like to a PDC mobile terminal, to perform communication restriction. If the communication protocol is applied to a WCDMA system, on the other hand, the mobile terminal communication restricting device 1 transmits, for example, an “active set update” (settings update) message, a “radio resource control (RRC) connection release” (connection release) message, or a like to a WCDMA mobile terminal, to perform communication restriction. That the communication restricting state is OFF upon reception of the layer-3 wireless channel establishment requesting message is decided on the basis of the value (=1) of the communication restricting counter.

If the layer-3 wireless channel rejecting message is transmitted at step F7 (7-1), the value of the communication restricting state counter is reset to “0”. If the layer-3 wireless channel disconnecting message is transmitted at step F7 (7-2), the held information such as a service type (circuit switching service or packet switching service) and a mobile terminal type is released, to update the value of the communication restricting state counter to “0”.

As described above, in the present embodiment, the mobile terminal communication restricting device 1 transmits to the cellular phone 2 a layer-3 wireless channel rejecting message or a layer-3 wireless channel disconnecting message, which are actually used in the existing mobile communication network NW, so that communication restriction is performed without remodeling the cellular phone 2 or allocating a new frequency. Further, the mobile terminal communication restricting device 1 identifies a service type (circuit switching service or packet switching service) based on a received layer-3 wireless channel establishment requesting message, so that communication restriction is performed on at least one of the service types (for example, circuit switching service). Further, when mounted in a vehicle (for example, the automobile), the mobile terminal communication restricting device 1 performs communication restriction on the cellular phone 2 without the existing mobile communication network NW having to detect or monitor positional information of the cellular phone 2 or the automobile. Furthermore, the mobile terminal communication restricting device 1 performs communication restriction on the cellular phone 2 if a moving speed of the vehicle is detected by the speed detecting section 16 to have exceeded a predetermined speed threshold value, so that when the vehicle mounted with the mobile terminal communication restricting device 1 is at a halt, communication restriction is prevented from being performed on the cellular phone 2.

Although the embodiment of the present invention has been described in detail, the specific configuration is not limited to this embodiment. Any changes in design not departing from the gist of the present invention are covered by the present invention.

For example, the mobile terminal communication restricting device according to the present invention can be applied not only to the PDC system and the WCDMA system, but also to an arbitrary type of a system that accommodates a mobile terminal, such as a global system for mobile communication (OSM) system, for example. Further, the mobile terminal may not only be the cellular phone 2 but also be a personal digital assistant (PDA). Further, in FIG. 1, a plurality of the cellular phones 2 may be provided in place of the single cellular phone 2. Further, the speed detecting section 16 may be omitted if the mobile terminal communication restricting device 1 is placed in, for example, a movie theater or a hospital other than a vehicle. Further, in this case, the speed threshold value may be set to 0 km/h.

If the mobile terminal communication restricting device 1 is equipped with timekeeping means (timer), the mobile terminal communication restricting device 1 can be used for communication restriction in, for example, a school by setting a time zone during which communication restriction is performed.

1. A mobile terminal communication restricting device for performing communication restriction on a call-in or call-out occurring between a mobile terminal, which is wireless-connected to an existing communication network that is based on an Open Interconnection protocol, and the existing mobile communication network if said mobile terminal is within a moving vehicle or within a specified location, the mobile terminal communication restricting device: configured to transmit to said mobile terminal a communication restricting message, which is actually used in said existing mobile communication network, for informing said mobile terminal of performing the communication restriction on a layer-3 of the Open Systems Interconnection protocol, if the call-in or call-out has occurred between said mobile terminal and said existing mobile communication network.

2. The mobile terminal communication restricting device according to claim 1, provided with a communication restricting switch for determining, by switchover, whether to perform the communication restriction so that if a layer-3 wireless channel establishment requesting message actually used in said existing mobile communication network is received from said mobile terminal when said communication restricting switch is ON, a layer-3 wireless channel rejecting message actually used in said existing mobile communication network is transmitted to said mobile terminal, to perform the communication restriction on said mobile terminal.

3. The mobile terminal communication restricting device according to claim 1, provided with a communication restricting switch for determining, by switchover, whether to perform the communication restriction so that if a layer-3 wireless channel establishment requesting message actually used in said existing mobile communication network is received from said mobile terminal when said communication restricting switch is OFF and, after that, said communication restricting switch is turned ON, a layer-3 wireless channel disconnecting message actually used in said existing mobile communication network is transmitted to said mobile terminal, to perform the communication restriction on said mobile terminal.

4. The mobile terminal communication restricting device according to claim 2, further configured to identify service type information indicative of circuit switching service or packet switching service based on the layer-3 wireless channel establishment requesting message received from said mobile terminal, and to transmit the layer-3 wireless channel rejecting message to said mobile terminal using at least one of said circuit switching service and said packet switching service.

5. The mobile terminal communication restricting device according to claim 3, further configured to identify service type information indicative of circuit switching service or packet switching service based on the layer-3 wireless channel establishment requesting message received from said mobile terminal, and to transmit the layer-3 wireless channel disconnecting message to said mobile terminal using at least one of said circuit switching service and said packet switching service.

6. The mobile terminal communication restricting device according to claim 1, configured to perform the communication restriction only when a moving speed of the vehicle has exceeded a predetermined speed threshold value, when mounted in the vehicle.

7. A communication restricting method used in a mobile terminal communication restricting device for performing communication restriction on a call-in or call-out occurring between a mobile terminal, which is wireless-connected to an existing communication network that is based on an Open Systems Interconnection protocol, and said existing mobile communication network if said mobile terminal is within a moving vehicle or within a specified location, the method comprising:
checking whether the call-in or call-out has occurred between said mobile terminal and said existing mobile communication network; and
transmitting to said mobile terminal a communication restricting message, which is actually used in said existing mobile communication network, for informing said mobile terminal of performing the communication restriction on a layer-3 of the Open Systems Interconnection protocol, if the call-in or call-out has occurred.

8. The communication restricting method according to claim 7, further comprising the step of: using a communication restricting switch for determining, by switchover, whether to perform the communication restriction so that if a layer-3 wireless channel establishment requesting message actually used in said existing mobile communication network is received from said mobile terminal when said communication restricting switch is ON, a layer-3 wireless channel rejecting message actually used in said existing mobile communication network is transmitted to said mobile terminal, to perform the communication restriction on said mobile terminal.

9. The communication restricting method according to claim 7, further comprising the step of: using a communication restricting switch for determining, by switchover, whether to perform the communication restriction so that if a layer-3 wireless channel establishment requesting message actually used in said existing mobile communication network is received from said mobile terminal when said communication restricting switch is OFF and, after that, said communication restricting switch is turned ON, a layer-3 wireless channel disconnecting message actually used in said existing mobile communication network is transmitted to said mobile terminal, to perform the communication restriction on said mobile terminal.

10. The communication restricting method according to claim 8, further comprising the step of: identifying service type information indicative of circuit switching service or packet switching service based on the layer-3 wireless channel establishment requesting message received from said mobile terminal, and transmitting the layer-3 wireless channel rejecting message to said mobile terminal using at least one of said circuit switching service and said packet switching service.

11. The communication restricting method according to claim 9, further comprising the step of: identifying service type information indicative of circuit switching service or packet switching service based on the layer-3 wireless channel establishment requesting message received from said mobile terminal, and transmitting the layer-3 wireless channel disconnecting message to said mobile terminal using at least one of said circuit switching service and said packet switching service.

12. The communication restricting method according to claim 7, further comprising the step of: performing the communication restriction only when a moving speed of the vehicle has exceeded a predetermined speed threshold value, and when said mobile terminal communication restricting device is mounted in the vehicle.

13. A communication restricting program for causing a computer to execute a communication restricting method used in a mobile terminal communication restricting device for performing communication restriction on a call-in or call-out occurring between a mobile terminal, which is wireless-connected to an existing communication network that is based on an Open Systems Interconnection protocol, and said existing mobile communication network if said mobile terminal is within a moving vehicle or within a specified location, the method comprising the steps of:
checking whether the call-in or call-out has occurred between said mobile terminal and said existing mobile communication network; and
transmitting to said mobile terminal a communication restricting message, which is actually used in said existing mobile communication network, for informing said mobile terminal of performing the communication restriction on a layer-3 of the Open Systems Interconnection protocol, if the call-in or call-out has occurred.

14. A communication restricting program according to claim 13, the method further comprising the step of: using a communication restricting switch for determining, by switchover, whether to perform the communication restriction so that if a layer-3 wireless channel establishment requesting message actually used in said existing mobile communication network is received from said mobile terminal when said communication restricting switch is ON, a layer-3 wireless channel rejecting message actually used in said existing mobile communication network is transmitted to said mobile terminal, to perform communication restriction on said mobile terminal.

15. A communication restricting program according to claim 13, the method further comprising the step of: using a communication restricting switch for determining, by switchover, whether to perform the communication restriction so that if a layer-3 wireless channel establishment requesting message actually used in said existing mobile communication network is received from said mobile terminal when said communication restricting switch is OFF and, after that, said communication restricting switch is turned ON, a layer-3 wireless channel disconnecting message actually used in said existing mobile communication network is transmitted to said mobile terminal, to perform communication restriction on said mobile terminal.

16. A communication restricting program according to claim 14, causing a computer to execute identifying service type information indicative of circuit switching service or packet switching service based on the layer-3 wireless channel establishment requesting message received from said mobile terminal, and transmitting the layer-3 wireless channel rejecting message to said mobile terminal using at least one of said circuit switching service and said packet switching service.

17. A communication restricting program according to claim 15, causing a computer to execute further identifying service type information indicative of circuit switching service or packet switching service based on the layer-3 wireless channel establishment requesting message received from said mobile terminal, and transmitting the layer-3 wireless channel disconnecting message to said mobile terminal using at least one of said circuit switching service and said packet switching service.
